(19) United States
(12) Patent Application Publication
(10) Pub. No.: US 2018/0111659 A1
(43) Pub. Date: Apr. 26, 2018

(54) Bicycle Pedal Extension Apparatus

(71) Applicant: PedalX, LLC, Roanoke, IN (US)

(72) Inventor: Matthew Rasbury, Roanoke, IN (US)

(21) Appl. No.: 15/789,947

(22) Filed: Oct. 20, 2017

Related U.S. Application Data
(60) Provisional application No. 62/411,327, filed on Oct. 21, 2016.

(51) Int. Cl. B62M 3/16; B62M 3/08

(52) U.S. Cl. CPC B62M 3/16; B62M 1/36; B62M 3/08

(57) ABSTRACT

An apparatus, system, and method for extending a bicycle pedal away from a bicycle frame, comprising a coupling member configured to removably attach to a bicycle pedal, and a plug member comprising a proximal end configured to be removably attached to a bicycle pedal crank arm and a distal end configured to be removably inserted into said coupling member.

### CROSS REFERENCES TO OTHER APPLICATIONS

This Application claims priority to and incorporates fully by reference U.S. Provisional Application No. 62/411,327, Bicycle Pedal Extension Apparatus, filed on Oct. 21, 2016.

### STATEMENT REGARDING FEDERALLY SPONSORED RESEARCH OR DEVELOPMENT

Not applicable.

### BACKGROUND

While riding a bicycle, it is desirable to maintain an appropriate distance between the rider's feet. On standard bicycles with preinstalled pedals, the distance between the pedals is often too close for an individual rider's optimal stance. This forces riders to keep their feet too close together while pedaling the bicycle, and makes riders more susceptible to leg pains and knee injuries.

Bicycle riders can reduce their risk of leg and knee injuries by widening their stance on the bicycle pedals, thus preventing their knees from bowing in an outward direction while pedaling the bicycle. This can be accomplished by riding a bicycle with a greater distance between each individual pedal and the bicycle frame, which allows riders to pedal without having to bow their knees outward.

However, many standard bicycles suffer a number of deficiencies. Primarily, preinstalled pedals on bicycles are often installed too closely to the bicycle frame. Further, many bicycles do not provide any means for adjusting the distance between each individual pedal and the bicycle frame, thus preventing riders from attaining the optimal distance between their feet to reduce risk of injuries while riding bicycles. Summary

In certain aspects, the present invention is directed to an apparatus to extend a bicycle pedal away from a bicycle frame. Generally, embodiments of the present invention comprise a coupling member and a plug member, wherein said coupling member comprises a first aperture configured to removably attach to a bicycle pedal and a second aperture configured to receive a plug member, said first aperture and said second aperture being in fluid connection, and said plug member comprises a proximal end configured to be removably attached to a bicycle pedal crank arm and a distal end configured to be removably attached to said coupling member second aperture.

Additional aspects of the present invention are directed to a bicycle pedal extender system. Embodiments generally comprise a bicycle with a bicycle pedal crank arm, a bicycle pedal, a coupling member, and a plug member, wherein said coupling member comprises a first aperture removably attached to said bicycle pedal and a second aperture configured to receive the plug member, said first aperture and said second aperture being in fluid connection, and said plug member comprises a proximal end removably attached to said bicycle pedal crank arm and a distal end removably attached to said coupling member second aperture.

Further aspects of the present invention are directed to a method of extending the distance between a bicycle frame and a bicycle pedal. The method generally comprises removably attaching a bicycle pedal stub to a second aperture of a coupling member while a plug member is detached from the coupling member, removably attaching a plug member to a first aperture of said coupling member, and removably attaching said plug member to a bicycle pedal crank arm.

### BRIEF DESCRIPTION OF THE DRAWINGS

These and other features, aspects, and advantages of the present invention will become better understood with regard to the following description and accompanying drawings, wherein:

FIG. 1 shows a perspective view of a preferred embodiment of the present invention;

FIG. 2 shows an exploded perspective view of a preferred embodiment of the present invention;

FIG. 3 shows an exploded perspective view of a coupling member and a plug member from a preferred embodiment of the present invention; and

FIG. 4 shows an exploded perspective view of a coupling member and a plug member from a preferred embodiment of the present invention.

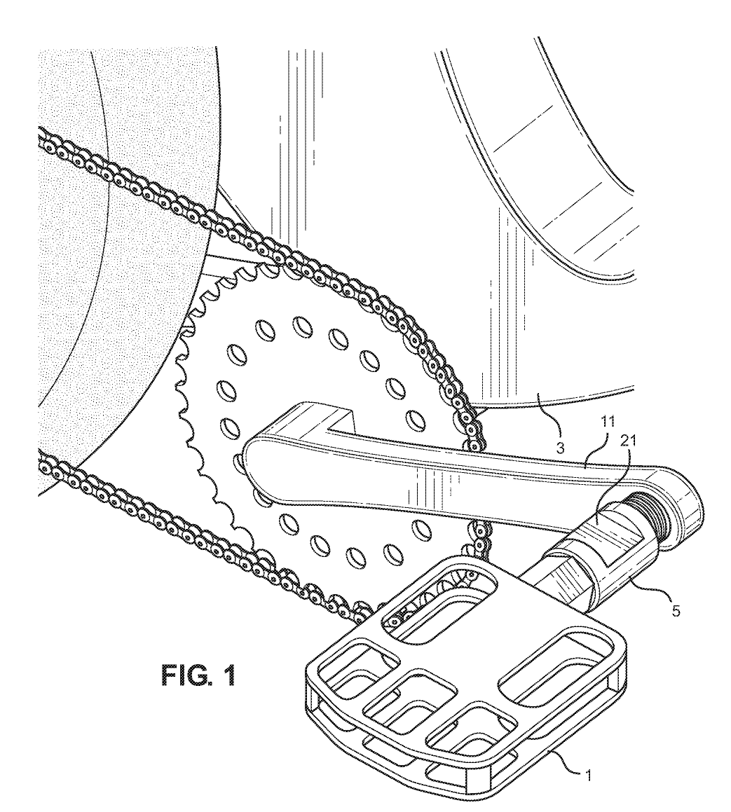

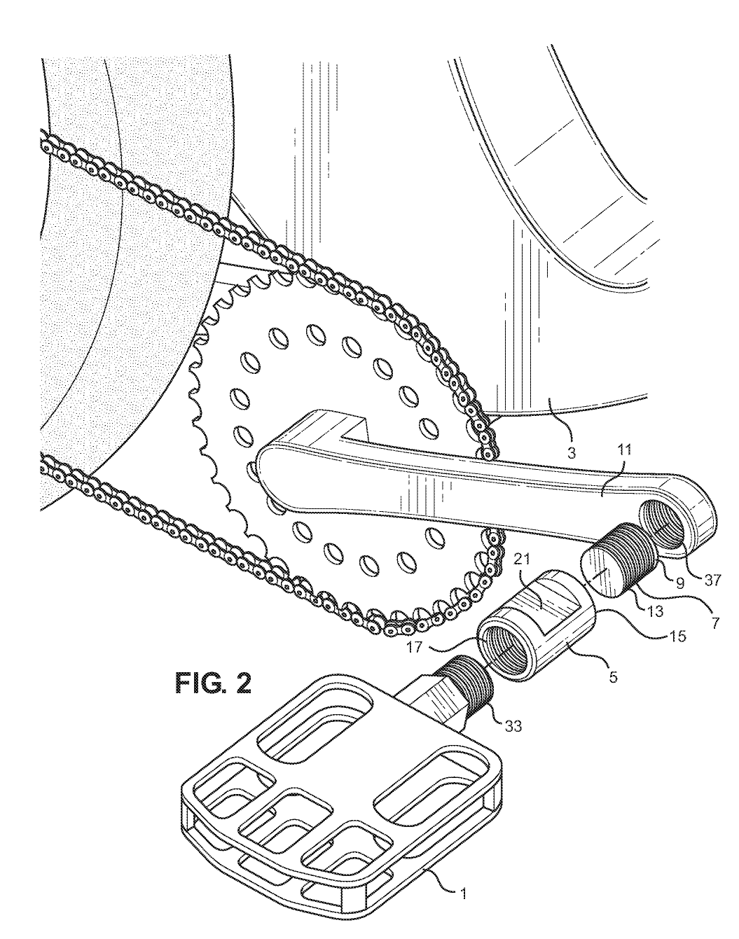

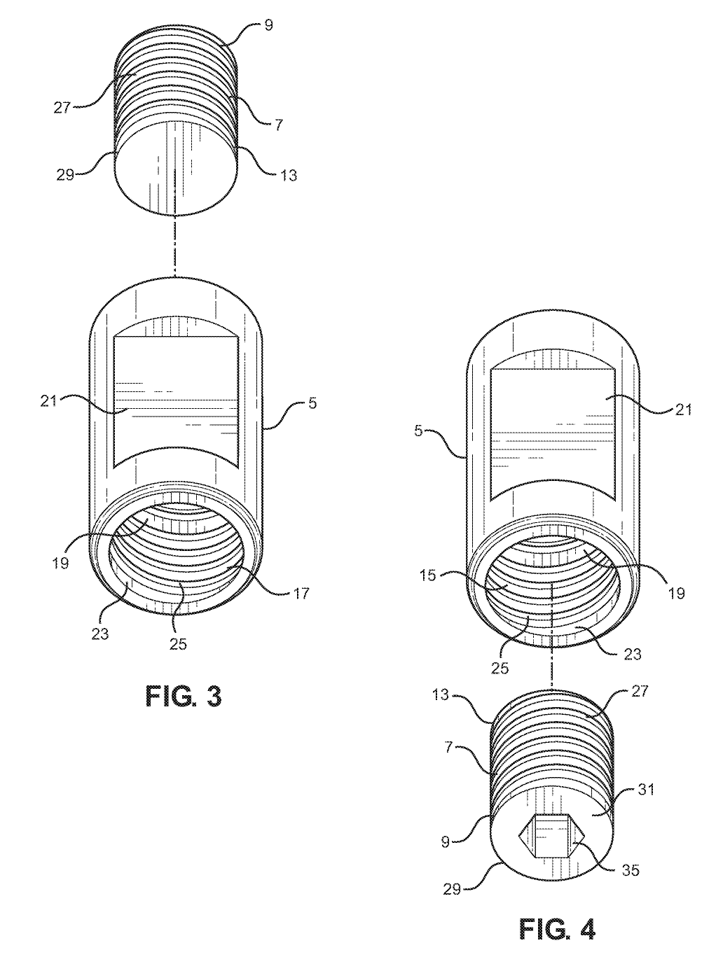

### DETAILED DESCRIPTION

Embodiments of the present invention are directed towards an apparatus for extending a bicycle pedal (1) away from a bicycle frame (3). In preferred embodiments, the apparatus comprises a coupling member (5) and a plug member (7). The coupling member (5) is configured to removably attach to a bicycle pedal (1), and the plug member (7) comprises a proximal end (9) configured to be removably attached to a bicycle pedal crank arm (11) and a distal end (13) configured to be removably attached to said coupling member (5). Accordingly, in preferred embodiments, the apparatus increases the distance between an individual bicycle pedal (1) and a bicycle frame (3).

Additional embodiments of the present invention are directed towards a bicycle and pedal extender system. In preferred embodiments, the system comprises a bicycle frame (3) and a bicycle pedal crank arm (11), a bicycle pedal (1) comprising a threaded bicycle pedal stub (33), a coupling member (5), and a plug member (7). The coupling member (5) is removably attached to the bicycle pedal stub (33), and the plug member (7) comprises a proximal end (9) removably attached to a threaded opening (37) in the bicycle pedal crank arm (11) and a distal end (13) removably attached to said coupling member (5). Accordingly, in preferred embodiments, the system increases the distance between an individual bicycle pedal (1) and a bicycle frame (3).

In preferred embodiments of the present invention, the coupling member (5) comprises a first aperture (15) and a second aperture (17), said first aperture (15) and said second aperture (17) being in fluid connection with in each other and defining a passage through said coupling member (5). A circumferential shoulder (19) within said coupling member (5) defines a point of separation between said first aperture (15) and said second aperture (17), and further defines a stopping point for the plug member (7) when the plug member (7) is removably inserted into the coupling member (5). The coupling member (5) further preferably comprises an external profile comprising at least one flat surface (21) configured to facilitate turning of the coupling member (5) about its longitudinal axis by a wrench.

The first aperture (15) and the second aperture (17) each have an inner circumference (23), and such inner circumferences (23) preferably comprise female threading (25). Preferably, the second aperture (17) of the coupling member (5) is configured to removably attach to a bicycle pedal (1) by threaded connection between the male threading (27) of a bicycle pedal stub (33) and cooperative female threading (25) of the second aperture (17), and the first aperture (15) is configured to removably attach to a plug member (7) by threaded connection between the female threading (25) of the first aperture (15) and cooperative male threading (27) of the plug member (7). The inner diameter of the coupling member (5) and the outer diameter of the plug member (7) are each sized to match the diameter of the bicycle pedal stub (33), which are most commonly either 9/16 inch in diameter or ½ inch in diameter.

Further, in preferred embodiments, the plug member (7) has an outer circumference (29) and comprises both a proximal end (9) and a distal end (13). The outer circumference (29) of the plug member (7) is preferably approximately equal to the inner circumference (23) of the first aperture (15) of the coupling member (5). The plug member (7) is removably attached to the first aperture (15), as described above. When attached, the circumferential shoulder (19) within the coupling member (5) defines a stopping point for the plug member distal end (13) such that a portion of the plug member proximal end (9) protrudes past the opening of said first aperture (15). The protruding portion of the plug member proximal end (9) preferably comprises male threading (27), and is preferably of sufficient length for removable attachment to a bicycle crank arm (11), such as by threaded connection. In preferred embodiments, a proximal face (31) of the plug member (7) comprises a hex-shaped opening (35) configured to accept a hex wrench.

In preferred embodiments, the plug member (7) provides additional structural support to the pedal extending assembly when the distal end (13) of the plug member (7) is removably connected to the first aperture (15) of the coupling member (5).

In use, the present invention first involves removably attaching a bicycle pedal stub (33) to the second aperture (17) of the coupling member (5) while the plug member (7) is detached from the coupling member (5), preferably by threaded connection as described above. Bicycle pedal stubs (33) are commonly configured so that the stub (33) can accept a hex wrench, to facilitate tightening. Once the bicycle pedal stub (33) is inserted into the second aperture (17), preferably by threaded connection, the pedal stub (33) may be engaged by a hex wrench through the open first aperture (15). The coupling member (5) may then be turned by a wrench to tighten the coupling member (5) to the bicycle pedal (1) to a desired torque.

Next, the distal end (13) of the plug member (7) is removably attached to the first aperture (15) of the coupling member (5), again preferably by threaded connection, and preferably until the distal end (13) of the plug member (7) seats against the circumferential shoulder (19) within the coupling member (5). A portion of the proximal end (9) of the plug member (7) will protrude past the end of the first aperture (15). This protruding portion is removably attached to a bicycle pedal crank arm (11), preferably by threading. The proximal face (31) of the plug member (7) may be engaged with a hex wrench while the coupling member (5) or crank arm (11) are turned by a wrench, to facilitate tightening to the desired torque. Assembling preferred embodiments in this manner further assures that additional structural support will be provided by the present invention when used in a bicycle pedal assembly.

In one embodiment of the invention, the inner circumference (23) of the first aperture (15) of the coupling member (5) comprises female threading (25) formed in a right-hand direction, and the outer circumference (29) of the plug member (7) comprises male threading (27) in a right-hand direction, such that screwing the plug member (7) into the first aperture (15) of the coupling member (5) in a right-hand direction, or a clockwise direction, results in the plug member (7) being removably inserted into the first aperture (15) of the coupling member (5). Such an embodiment is preferably installed on a pedal (1) on the left-hand side of a bicycle frame (3). Installing the embodiment in this way prevents any unwanted removal of the plug member (7) out of the first aperture (15) of the coupling member (5) when a bicycle rider rotates the pedal (1) on the left-hand side of a bicycle frame (3) in a counterclockwise direction.

Additionally, in certain embodiments, the inner circumference (23) of the second aperture (17) of the coupling member (5) comprises female threading (25) formed in a right-hand direction, such that screwing a bicycle pedal stub (33) into the second aperture (17) of the coupling member (5) in a right-hand direction, or a clockwise direction, results in the bicycle pedal stub (33) being removably inserted into the second aperture (17) of the coupling member (5). Such an embodiment is preferably installed on a pedal (1) on the left-hand side of a bicycle frame (3). Installing the embodiment in this way prevents any unwanted removal of a bicycle pedal stub (33) out of the second aperture (17) of the coupling member (5) when a bicycle rider rotates the pedal (1) on the left-hand side of a bicycle frame (3) in a counterclockwise direction.

Likewise, in another embodiment of the invention, the inner circumference (23) of the first aperture (15) of the coupling member (5) comprises female threading (25) formed in a left-hand direction, and the outer circumference (29) of the plug member (7) comprises male threading (27) in a left-hand direction, such that screwing the plug member (7) into the first aperture (15) of the coupling member (5) in a left-hand direction, or a counterclockwise direction, results in the plug member (7) being removably inserted into the first aperture (15) of the coupling member (5). Such an embodiment is preferably installed on a pedal (1) on the right-hand side of a bicycle frame (3). Installing the embodiment in this way prevents any unwanted removal of the plug member (7) out of the first aperture (15) of the coupling member (5) when a bicycle rider rotates the pedal (1) on the right-hand side of a bicycle frame (3) in a clockwise direction.

Additionally, in other embodiments, the inner circumference (23) of the second aperture (17) of the coupling member (5) comprises female threading (25) formed in a left-hand direction, such that screwing a bicycle pedal (1) into the second aperture (17) of the coupling member (5) in a left-hand direction, or a counterclockwise direction, results in the bicycle pedal stub (33) being removably inserted into the second aperture (17) of the coupling member (5). Such an embodiment is preferably installed on a pedal (1) on the right-hand side of a bicycle (15). Installing the embodiment in this way prevents any unwanted removal of a bicycle pedal (1) out of the second aperture (17) of the coupling member (5) when a bicycle rider rotates the pedal (1) on the right-hand side of a bicycle frame (3) in a clockwise direction.

Embodiments of the present invention can vary as to their material of manufacture. Preferred materials are steel, titanium and materials of equal or greater strength. Embodiments of the present invention may further vary in length to vary the distance of offset of the pedal (1) from the bicycle frame (3), as will be appreciated by one skilled in the art. In a preferred embodiment, the coupling member (5) is approximately 25 millimeters in length.

Although the present invention has been described in considerable detail with reference to certain preferred versions thereof, other versions are possible. For example, materials, shapes, sizes, or configurations other than those described in detail herein may be used for the versions of this invention. Therefore, the spirit and scope of the claims should not be limited to the description of the preferred versions described herein.

What is claimed is:

1. An apparatus for extending a bicycle pedal away from a bicycle frame, said apparatus comprising:
a. a coupling member, said coupling member comprising a first aperture having an inner circumference and a second aperture having an inner circumference, said first aperture and said second aperture being in fluid connection and further being separated by a circumferential shoulder within said coupling member, wherein said first aperture is configured to removably attach to a plug member and said second aperture is configured to removably attach to a bicycle pedal; and
b. a plug member comprising an outer circumference, a distal end, a proximal end, and a proximal face, said outer circumference being approximately equal to the inner circumference of said first aperture, said distal end configured to be removably attached to said first aperture, and said proximal end configured to be removably attached to a bicycle pedal crank arm.

2. The apparatus of claim 1, wherein each of the inner circumference of said first aperture and the inner circumference of said second aperture comprise female threading.

3. The apparatus of claim 2, wherein the outer circumference of said plug member comprises male threading and is threaded cooperatively with one or more of the inner circumference of said first aperture and the inner circumference of said second aperture.

4. The apparatus of claim 3, wherein the inner circumference of said first aperture comprises right-hand female threading, and said outer circumference of said plug member comprises right-hand male threading.

5. The apparatus of claim 3, wherein the inner circumference of said first aperture comprises left-hand female threading, and said outer circumference of said plug member comprises left-hand male threading.

6. The apparatus of claim 3, wherein said proximal face comprises a hex-shaped opening configured to allow insertion of an adjusting tool.

7. The apparatus of claim 6, wherein said coupling member is approximately 25 millimeters in length.

8. The apparatus of claim 6, wherein said coupling member is approximately 31 millimeters in length.

9. A bicycle pedal extension system, said system comprising:
a. a bicycle frame and a bicycle pedal crank arm, said bicycle pedal crank;
b. a bicycle pedal, said bicycle pedal comprising a bicycle pedal stub;
c. a coupling member, said coupling member comprising a first aperture having an inner circumference and a second aperture having an inner circumference, said first aperture and said second aperture being in fluid connection and further being separated by a circumferential shoulder within said coupling member, wherein said first aperture is removably attached to a plug member and said second aperture is removably attached to said bicycle pedal; and
d. a plug member comprising an outer circumference, a distal end, a proximal end, and a proximal face, said outer circumference being approximately equal to the inner circumference of said first aperture, said distal end removably attached to said first aperture, and said proximal end removably attached to said bicycle pedal crank arm.

10. The bicycle pedal extension system of claim 9, wherein said bicycle pedal stub comprises male threading.

11. The bicycle pedal extension system of claim 10, wherein said bicycle pedal crank arm comprises a threaded opening.

12. The bicycle pedal extension system of claim 11, wherein each of the inner circumference of said first aperture and the inner circumference of said second aperture comprise female threading.

13. The bicycle pedal extension system of claim 12, wherein the outer circumference of said plug member comprises male threading and is threaded cooperatively with one or more of the inner circumference of said first aperture, the inner circumference of said second aperture, and said threaded opening.

14. The bicycle pedal extension system of claim 13, wherein the inner circumference of said first aperture comprises right-hand female threading, and the outer circumference of said plug member comprises right-hand male threading.

15. The bicycle pedal extension system of claim 13, wherein the inner circumference of said first aperture comprises left-hand female threading, and the outer circumference of said plug member comprises left-hand male threading.

16. The bicycle pedal extension system of claim 13, wherein said proximal face comprises a hex-shaped opening configured to allow insertion of an adjusting tool.

17. The bicycle pedal extension system of claim 13, wherein said coupling member is approximately 25 millimeters in length.

18. The bicycle pedal extension system of claim 13, wherein said coupling member is approximately 31 millimeters in length.

19. A method of extending the distance between a bicycle frame and its bicycle pedal comprising:
a. removably attaching a bicycle pedal stub to a second aperture of a coupling member while a plug member is detached from said coupling member;
b. removably attaching said plug member to a first aperture of said coupling member; and
c. removably attaching said plug member to a bicycle pedal crank arm.

20. The method of claim 19, wherein removably attaching said bicycle pedal stub to said second aperture of the coupling member is accomplished using a threaded connection.

21. The method of claim 19, wherein removably attaching said plug member to said first aperture of the coupling member is accomplished using a threaded connection.

22. The method of claim 19, wherein removably attaching said plug member to said bicycle pedal crank arm is accomplished by removably attaching said plug member to a threaded opening in said bicycle pedal crank arm.

23. The method of claim 19, further comprising engaging said pedal stub with a hex wrench through the open first aperture, and turning said hex wrench to tighten said coupling member to said bicycle pedal stub.

24. The method of claim 19, further comprising engaging a proximal face of said plug member by a hex wrench, and turning said coupling member or said bicycle pedal crank arm by a wrench to tighten said plug member to said bicycle pedal crank arm.
